(19) United States
(12) Patent Application Publication
(10) Pub. No.: US 2011/0063858 A1
(43) Pub. Date: Mar. 17, 2011

(54) Hexadecimal RGB and CMYK Light Reflecting Surfaces and Techniques

(76) Inventor: Sergio Alejandro Ortiz-Gavin, Los Angeles, CA (US)

(21) Appl. No.: 12/561,677

(22) Filed: Sep. 17, 2009

(51) Int. Cl. F21V 13/02; G02B 5/08; G02B 7/182

(52) U.S. Cl. 362/343; 359/871

(57) ABSTRACT

A light reflector having decimal and hexadecimal color models directly applied on light reflecting surfaces used in light reflecting equipment such as parabolic light reflectors and bounce boards. The color models on the reflecting surfaces produce desirable light in colors used in photographic and cinematography productions such as for stage, studio, video, motion picture and still photography.

### BACKGROUND OF THE INVENTION

1. Field of the Invention

The invention is directed to light reflectors with color models applied to reflecting skin surfaces to reflect light in desirable colors, color temperatures and specific targeted X/Y color coordinates used in specialty high end productions where exacting color rendition is demanded for use in stage, studio, video, and photographic productions.

2. Description of the Related Art

Techniques to produce light in many desirable colors for photography have been in use for many years. The equipment used in conventional techniques does not effectively exploit various color models that have been used in digital technologies such as computer monitors and digital cameras. Traditional surfaces are silver, white and sometimes gold. The present invention goes beyond the traditional and targets the color rendition of reflected light in a new way.

One color model is the RGB color model that refers to the colors red, green and blue. The RGB model is an additive model in which red, green and blue light are added together in various ways to produce a broad array of colors. A color is described by indicating how much of each of the red, green and blue colors are included. The color can be expressed as an RGB triplet and is commonly made up of three values each of which can vary from zero to a defined maximum.

The RGB values in decimal format are commonly specified using integers from 0 to 255 that represent the intensities of red, green and blue. For example, if all of the components are at zero, the result is black. If all are at maximum, the result is the brightest representable white. The color can be expressed as a hexadecimal string. The RGB hexadecimal values range from 00 00 00 to FF FF FF. The hexadecimal string 00 00 00 is black and the hexadecimal string FF FF FF is the brightest representable white. The color temperature and X/Y color coordinates targeted by the invention are all in the warm white to cold white range.

Another color model is the CMYK color model that refers to the colors cyan, magenta, yellow and key (or black). The CMYK model is a subtractive color model that works by masking certain colors on a typically white background. The CMYK color is commonly called out in percentages of each color that represent the intensities of the colors. If all of the components of the CMYK color model are at zero, the result is the brightest representable white. If all CMYK colors are at their maximum, the result is a black. In the CMYK model, white is the natural color of the paper or other background, while black results from a full combination of the colors.

Conventional techniques have failed to bridge the gap between digital technology and hardware to produce desirable light in color. A need exists for improved light reflecting apparatus that apply the benefits of digital technology directly to the hardware to produce light with desirable color properties for use in photography. The changes in color temperature and X/Y color coordinates are subtle yet drastic when viewed by a knowledgeable photographer, art director, cinematographer or director of photography.

### SUMMARY OF THE INVENTION

The invention applies decimal and hexadecimal color models directly to a light reflecting surface to produce light for photographic productions. The invention includes parabolic photography umbrellas and reflectors used for stage, studio, video, motion picture and still photography.

The invention further includes light bounces or bounce boards, which include hand held bounce disks, ovals and large bounce frames, spring loaded collapsible bounces, rags on large frames like ultra-bounce disks and large bounce frames used in place of ultra-bounce disks. The invention includes use with soft boxes, octobanks and strip lights commonly used in photography.

In embodiments, an RGB triplet value for a color is located in decimal or hexadecimal format from a standard chart well known to skilled persons. For example, the website at www.psyclops.com/tools/RGB is one which shows an interactive tool that allows a user to change colors on the screen by adding or subtracting RGB values. The selected RGB color space or triplet pattern is printed onto a white reflective material that can be adapted to conform to a shape to reflect light in a light reflector.

The invention includes using different geometric shapes or tessellations to form the RGB or CMYK color pattern on the skin. Further embodiments include artistic designs on the skin using the RGB or CMYK color models that can be used in or with photographic or cinematographic parabolic umbrella skins, reflectors or bounce material. These are used to reflect light off of the tessellations or the designs on the skins. The reflected light then combines to reproduce differing light shades used for stage, studio, video or photographic productions.

The invention includes the use of reflector umbrella skins made from a reflective textile or other reflective materials known to skilled persons to reflect light, including but not limited to textiles, fabric materials and aluminum metalized foil laminated to a black polyester backing material, all of which are within the scope of the present invention.

Color changes are achieved by altering, manipulating or rearranging the RGB or CMYK tessellations as determined from the standard charts or tables. In embodiments, a pattern of a selected combination of RGB or CMYK color spaces is applied directly onto the reflector skin. Different light sources will require different tessellations targeted specifically and designed with a quality of light for the exact application.

The reflector skin is then secured to a light reflector, such as a parabolic reflector, and the skin is configured to reflect light from the parabolic reflector's light source. In operation, the light reflected by the skin includes the colors based on the color space combination applied to the skin and this reflected light can be used to create desirable lighting effects.

If a different color of reflected lighting is desired, the user produces a different selected combination of RGB or CMYK color spaces, applies that combination to a second reflector skin and replaces the first skin with the second skin on the light reflector. Using the invention, a user can produce reflected light in many colors and shades by selecting the appropriate color space combination and geometric patterns placed on the reflector skin.

Other and further advantages will appear to skilled persons from the written disclosure and figures.

### BRIEF DESCRIPTION OF THE DRAWINGS

FIG. 1 is an elevation view illustrating an exemplary reflector skin used with a parabolic light reflector with the color tessellations on the reflector skin shown in FIG. 1A.

FIG. 1B is one color legend for the drawings showing that the tessellations are lined for color with the color red represented by vertical lining, the color green represented by horizontal lining and the color blue represented by diagonal lining.

FIG. 2 is an elevation view illustrating an exemplary reflector skin used with a parabolic light reflector with the color tessellations on the reflector skin shown in FIG. 2A.

FIG. 3 is an elevation view illustrating an exemplary reflector skin used with a parabolic light reflector with the color tessellations on the reflector skin shown in FIG. 3A.

FIG. 4 is an elevation view illustrating an exemplary reflector skin used with a parabolic light reflector with the color tessellations on the reflector skin shown in FIG. 4A.

FIG. 5 is an elevation view illustrating an exemplary reflector skin used with a parabolic light reflector with the color tessellations on the reflector skin shown in FIG. 5A.

FIG. 6 is an elevation view illustrating am exemplary reflector skin used with a parabolic light reflector with the color tessellations on the reflector skin shown in FIG. 6A.

FIG. 7 is an elevation view illustrating an exemplary reflector skin used with a parabolic light reflector with the color tessellations on the reflector skin shown in FIG. 7A.

FIG. 8 is an elevation view illustrating an exemplary reflector skin used with a parabolic light reflector with the color tessellations on the reflector skin shown in FIG. 8A.

FIG. 9 is an elevation view illustrating an exemplary reflector skin used with a parabolic light reflector with the color tessellations on the reflector skin shown in FIG. 9A.

FIG. 10 is an elevation view illustrating an exemplary reflector skin used with a parabolic light reflector with the color tessellations on the reflector skin shown in FIG. 10A.

FIG. 11 is an elevation view illustrating an exemplary reflector skin used with a parabolic light reflector with the color tessellations on the reflector skin shown in FIG. 11A.

FIG. 11B is one color legend for the drawings showing that the tessellations are lined for color with the color cyan represented by broken vertical lining, the color magenta represented by broken horizontal lining, the color yellow represented by vertical wavy lining and the color black represented by horizontal wavy lining.

FIG. 12 is an elevation view illustrating an exemplary reflector skin used with a parabolic light reflector with the color tessellations on the reflector skin shown in FIG. 12A.

FIG. 13 is an elevation view illustrating an exemplary reflector skin used with a parabolic light reflector with the color tessellations on the reflector skin shown in FIG. 13A.

FIG. 14 is an elevation view illustrating an exemplary reflector skin used with a parabolic light reflector with the color tessellations on the reflector skin shown in FIG. 14A.

FIG. 15 is an elevation view illustrating an exemplary reflector skin used with a parabolic light reflector with the color tessellations on the reflector skin shown in FIG. 15A.

FIG. 16 is an elevation view illustrating an exemplary reflector skin used with a parabolic light reflector with the color tessellations on the reflector skin shown in FIG. 16A.

FIG. 17 is an elevation view illustrating an exemplary reflector skin used with a parabolic light reflector with the color tessellations on the reflector skin shown in FIG. 17A.

FIG. 18 is an elevation view illustrating an exemplary reflector skin used with a parabolic light reflector with the color tessellations on the reflector skin shown in FIG. 18A.

FIG. 19 is an elevation view illustrating an exemplary reflector skin used with a parabolic light reflector with the color tessellations on the reflector skin shown in FIG. 19A.

FIG. 20 is an elevation view illustrating an exemplary reflector skin used with a parabolic light reflector with the color tessellations on the reflector skin shown in FIG. 20A.

FIG. 21 is an elevation view illustrating an exemplary reflector skin used with a parabolic light reflector with an exemplary design on the reflector skin shown in FIG. 21A.

FIG. 21B is one color legend for the embodiments illustrated in FIGS. 21 and 21A showing that the design is lined for color with the color red represented by vertical lining, the color green represented by horizontal lining and the color blue represented by diagonal lining.

FIG. 22 is an elevation view illustrating an exemplary reflector skin used with a parabolic light reflector with an exemplary design on the reflector skin shown in FIG. 22A.

FIG. 22B is one color legend for the embodiments illustrated in FIGS. 22 and 22A showing that these design is lined for color with the color cyan represented by broken vertical lining, the color magenta represented by broken horizontal lining, the color yellow represented by vertical wavy lining and the color black represented by horizontal wavy lining.

FIG. 23 illustrates an embodiment of the invention with a light source in combination with a light reflector umbrella with the color tessellations on the light reflector umbrella shown in FIG. 23A.

FIG. 23B is one color legend for the embodiments illustrated in FIGS. 23 and 23A showing that the tessellations are lined for color with the color red represented by vertical lining, the color green represented by horizontal lining and the color blue represented by diagonal lining.

FIG. 24 illustrates an embodiment of the invention with a light source in combination with a light reflecting parabolic umbrella with the color tessellations on the umbrella shown in FIG. 24A.

FIG. 24B is one color legend for the embodiments illustrated in FIGS. 24 and 24A showing that the tessellations are lined for color with the color cyan represented by broken vertical lining, the color magenta represented by broken horizontal lining, the color yellow represented by vertical wavy lining and the color black represented by horizontal wavy lining.

FIG. 25 illustrates an embodiment of the invention showing use with an exemplary light bounce board, FIG. 25A illustrates another embodiment showing use with another embodiment of a bounce board and FIG. 25B illustrates a further embodiment showing use with another embodiment of a bounce board.

FIG. 25C illustrates an embodiment of the color tessellations used with the bounce board embodiments shown in FIGS. 25, 25A and 25B.

FIG. 25D is a color legend for the embodiments shown in FIGS. 25, 25A and 25B illustrating that the tessellations are lined for color with the color red represented by vertical lining, the color green represented by horizontal lining and the color blue represented by diagonal lining.

FIG. 26 illustrates an embodiment of the invention showing use with an exemplary light bounce board, FIG. 26A illustrates another embodiment showing use with another embodiment of a bounce board and FIG. 26B illustrates a further embodiment showing use with another embodiment of a bounce board.

FIG. 26C illustrates the color tessellations used with the bounce board embodiments shown in FIGS. 26, 26A and 26B.

FIG. 26D is one color legend for the embodiments in FIGS. 26, 26A and 26B showing that the tessellations are lined for color with the color cyan represented by broken vertical lining, the color magenta represented by broken horizontal lining, the color yellow represented by vertical wavy lining and the color black represented by horizontal wavy lining.

### DETAILED DESCRIPTION OF EMBODIMENTS OF THE INVENTION

Reference is made to the Figures in which elements of the illustrated embodiments of the invention are given numerical designations so as to enable one skilled in the art to make and use the invention. It is understood that the following description is exemplary of embodiments of the invention and it is apparent to skilled persons that modifications are possible without departing from the inventive concepts herein described.

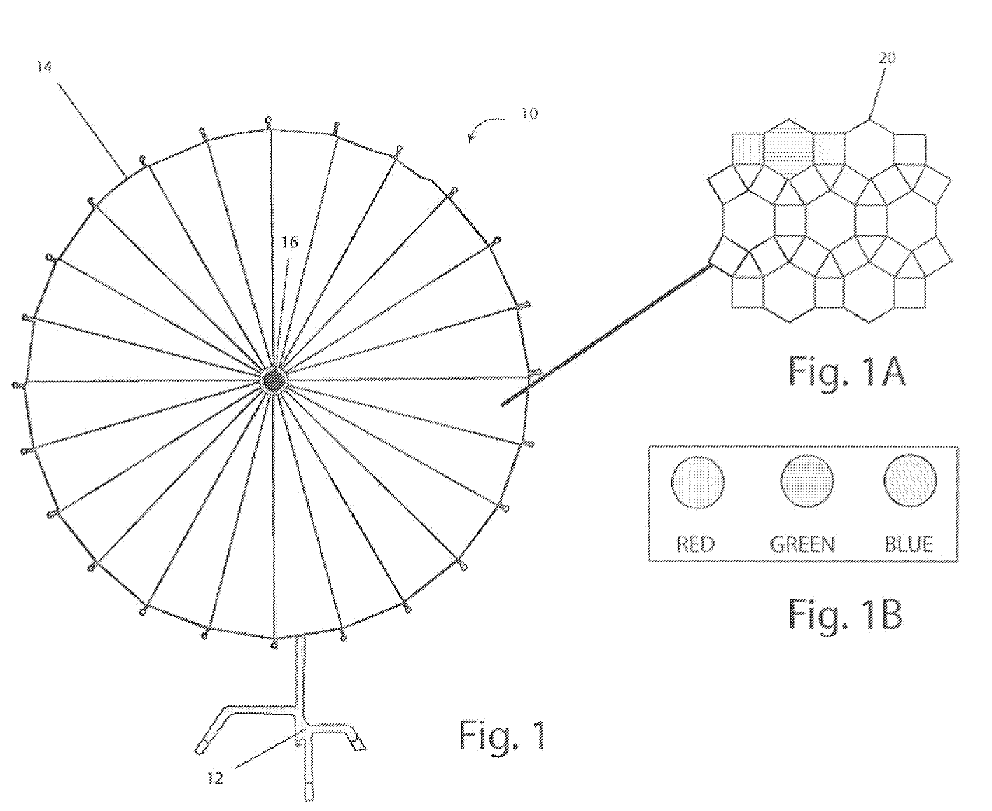

FIG. 1 illustrates an umbrella or light reflector 10 shown supported on a support 12 in a conventional manner with an attached umbrella skin 14. The light reflector 10 includes the parabolic reflectors known to persons skilled in the art. The light reflector 10 includes a center aperture 16 as shown in FIG. 1 for securing a light source thereto for use in stage, studio, motion picture and still photography.

In the embodiment shown in FIG. 1, the skin 14 is imprinted with a geometric pattern or tessellations 20 as shown in FIG. 1A. As used herein, tessellations refer to a tiling or composition of regular polygons in two dimensions, of polyhedral in three dimensions or of polytopes in n dimensions. The tessellations 20 are colored according to the chosen color space which for these embodiments is the RGB color space as illustrated in FIG. 1B. It is understood that FIG. 1A and the drawings of the tessellations 20 illustrate exemplary embodiments and that for clarity, the color lining is shown in the Figures applied only to selected individual tessellations 20. It is understood that the RGB color space is and can be applied to the tessellations 20 over the full pattern of the tessellations 20 as applied to the skin 14.

In embodiments of the invention, the skin 14 is made of any textile, and the skin 14 can be substantially flat or planar or the skin 14 can be embossed to give the skin 14 a three dimensional quality. In further embodiments, the skin 14 is aluminum, steel or any other kind of metal.

The geometric pattern or tessellations 20 are printed, painted or anodized directly on the surface of the skin 14, whether the skin 14 is made of a textile, metal or other material. The tessellations 20 can also be applied to the skin 14 by adhesive backed applications so that the tessellations 20 adhere to the skin 14 by the adhesive.

The RGB values can be changed by various methods known to skilled persons, including using an asymmetrical tessellation pattern on the skin 14, varying the size of the individual color tessellations, varying the intensity of the colors, varying the colors or by adding or subtracting individual color tessellations so that the number of individual red, green and blue tessellations is unequal or off-balance. In traditional RGB tessellations, the individual number of red, green and blue tessellations is equal.

The embodiments of the invention described herein allow users to choose reflected light with a different color. This is done by replacing the skin 14 on the light reflector 10 with a different skin 14 having tessellations 20 with the RGB color space as called for by the decimal or hexadecimal RGB values for the desired color of reflected light.

For example, the brightest representable white is Red 255 Green 255 Blue 255 in RGB decimal values or FF FF FF in hexadecimal values. One skin 14 can have this RGB color space printed thereon.

A warmer white light golden rod yellow is Red 250 Green 250 Blue 250 in decimal values or FA FA D2 in hexadecimal values. A replacement skin 14 can have this RGB color space printed thereon.

A colder white azure is Red 240 Green 255 Blue 255 in decimal values or F0 FF FF in hexadecimal values. Another replacement skin 14 can be printed with this RGB color space thereon. The alternatives and color options available to produce desired reflected light includes all available RGB color spaces and is not limited to white light.

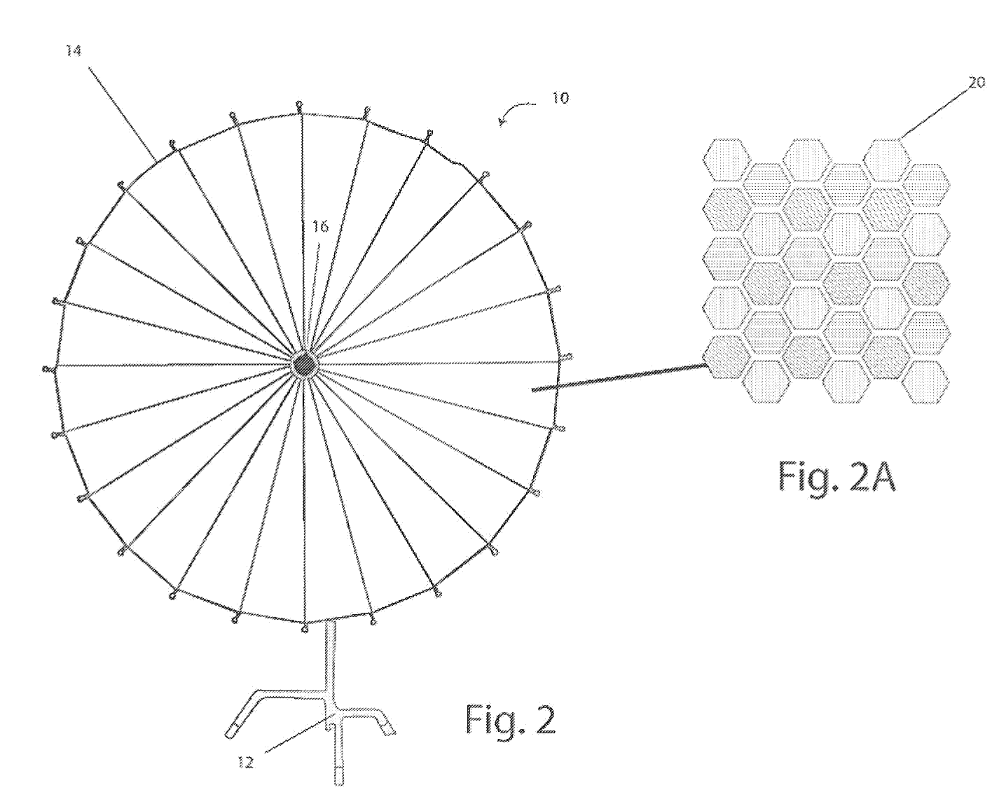

Alternative embodiments of the invention include the use of different tessellations to produce reflected light having desirable qualities. FIGS. 2-10 illustrate exemplary tessellations that can be used to reflect light of different colors using the RGB color space. The invention is not limited to the particular embodiments in the figures but includes geometric patterns that can be placed on the skin 14 with the RGB colors to produce desirable reflected light.

FIG. 2 illustrates an alternative embodiment with the tessellations 20 shown in a pattern of hexagon shapes which are imprinted onto the skin 14 and which have colors according to the RGB color space as illustrated in FIG. 1B.

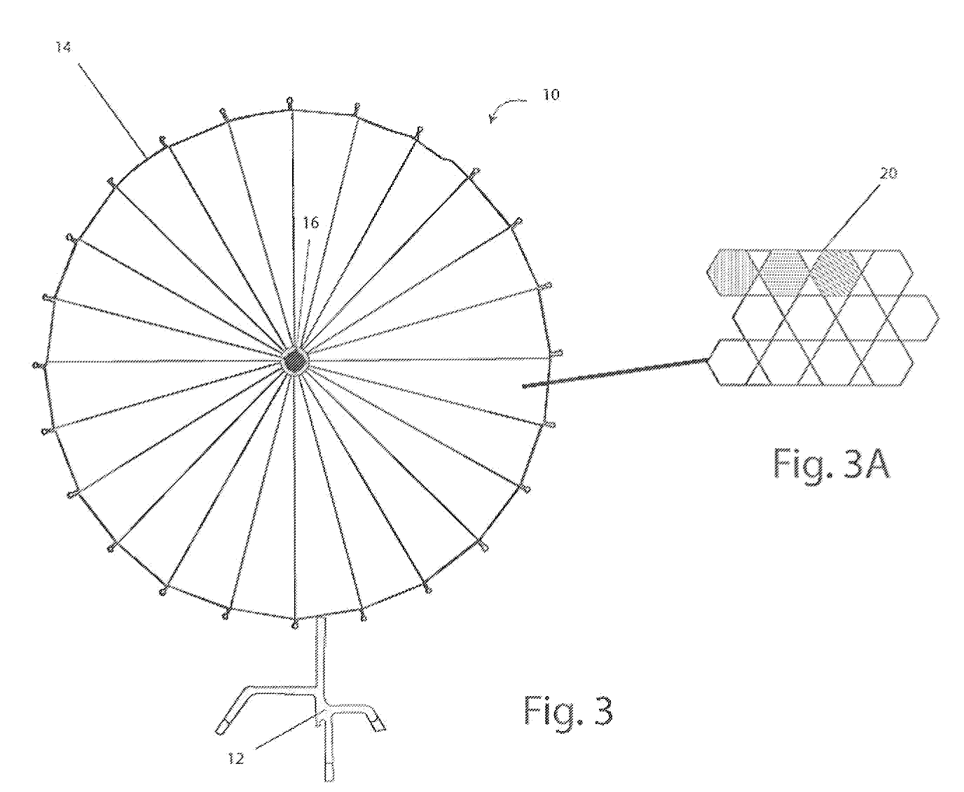

FIG. 3 illustrates an embodiment of tessellations 20 shown in an alternative pattern of hexagon shapes on the skin 14 and which have colors according to the RGB color space as illustrated in FIG. 1B.

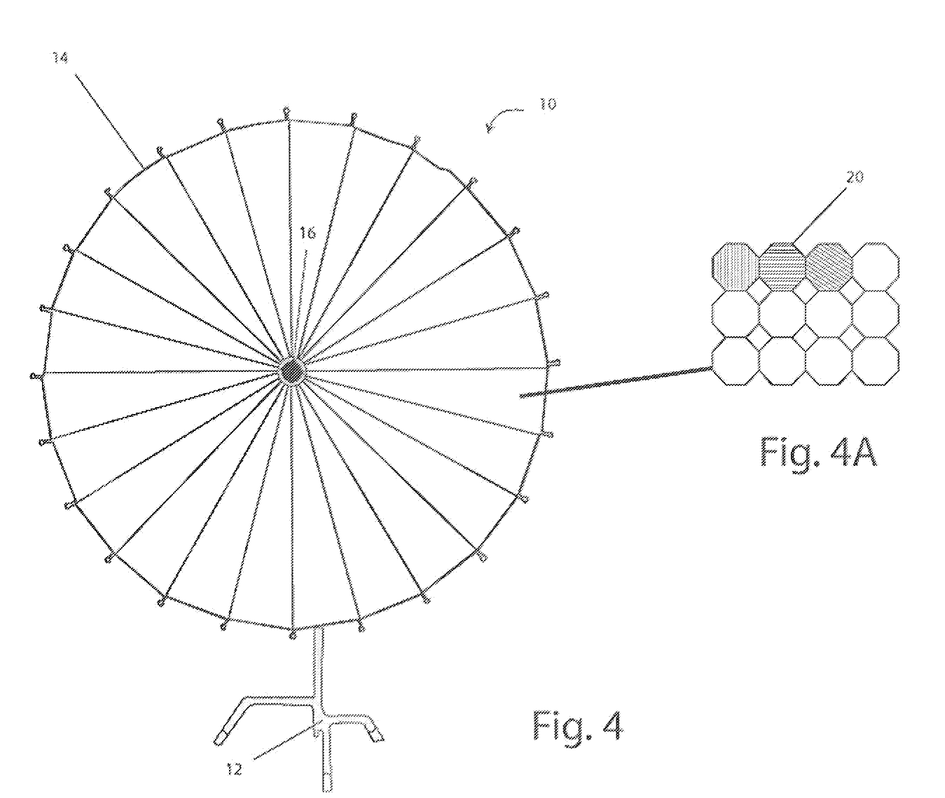

FIG. 4 illustrates an embodiment of tessellations 20 shown in another pattern of hexagon shapes on the skin 14 and which have colors according to the RGB color space as illustrated in FIG. 1B.

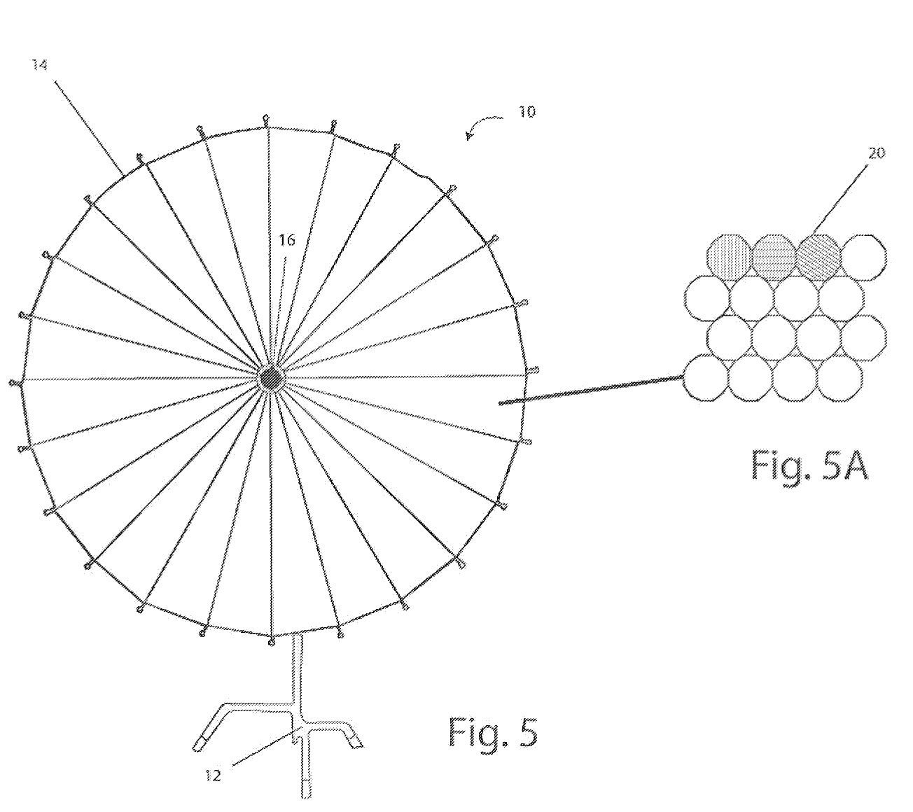

FIG. 5 illustrates an embodiment of tessellations 20 shown in a pattern of octagon shapes on the skin 14 and which have colors according to the RGB color space as illustrated in FIG. 1B.

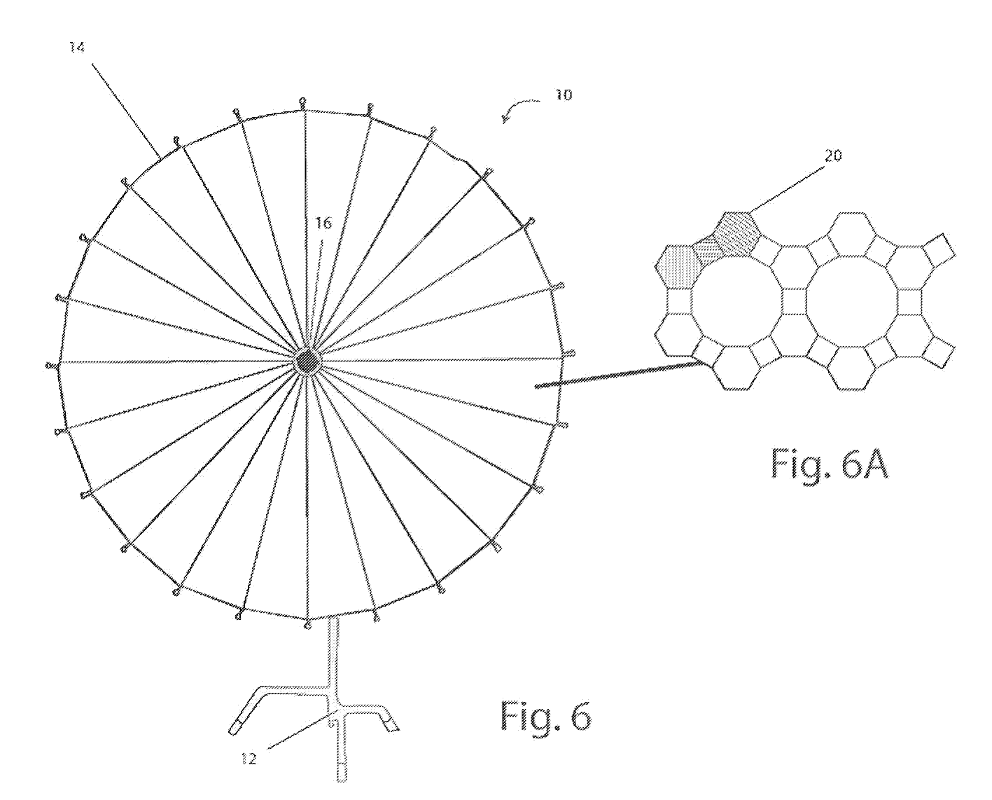

FIG. 6 illustrates an embodiment of tessellations 20 shown in an alternative pattern of polygons on the skin 14 and which have colors according to the RGB color space as illustrated in FIG. 1B.

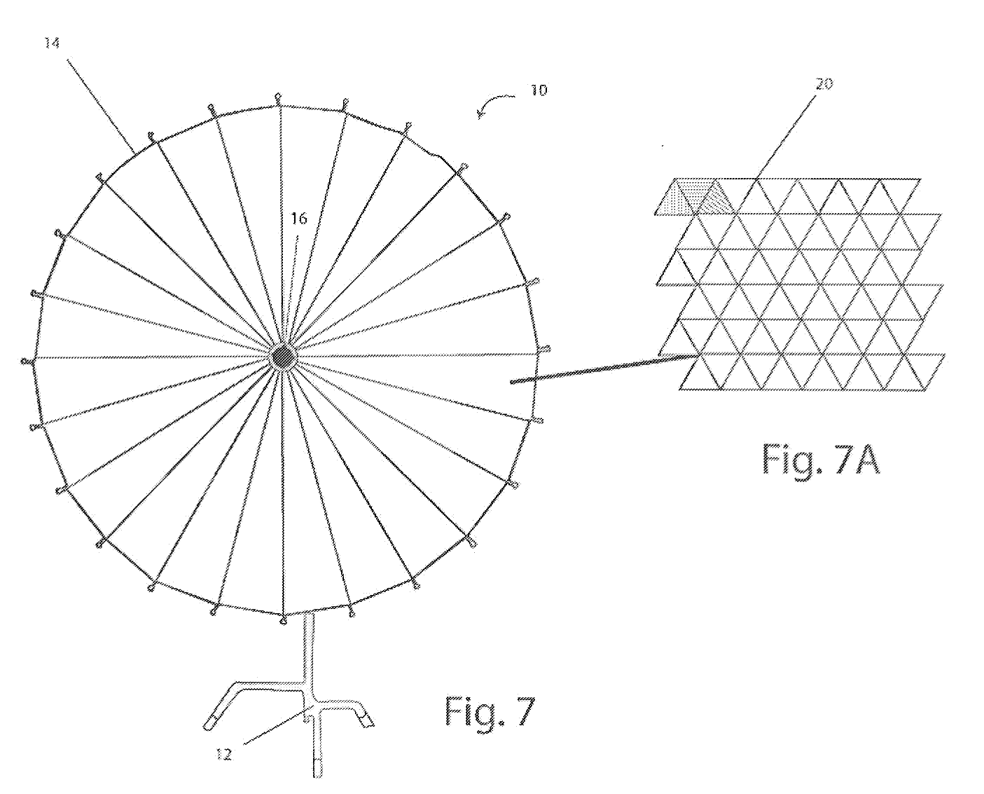

FIG. 7 illustrates an embodiment of tessellations 20 shown in a pattern of triangle shapes on the skin 14 and which have colors according to the RGB color space as illustrated in FIG. 1B.

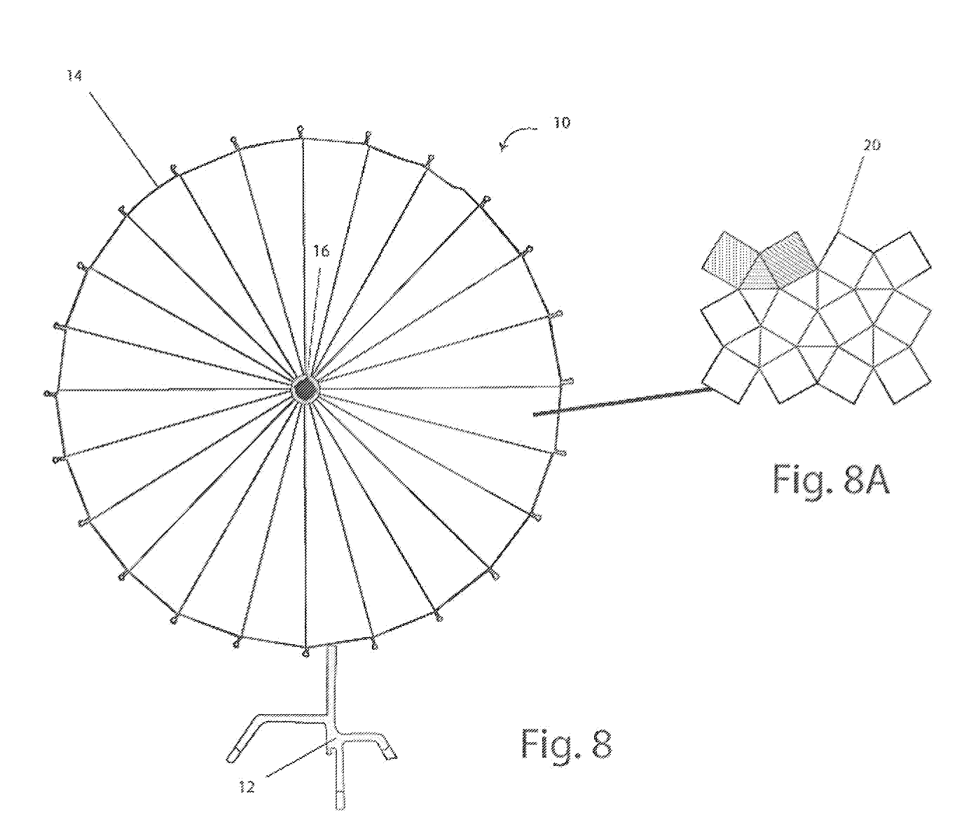

FIG. 8 illustrates an embodiment of tessellations 20 shown in a further alternative pattern of polygons on the skin 14 and which have colors according to the RGB color space as illustrated in FIG. 1B.

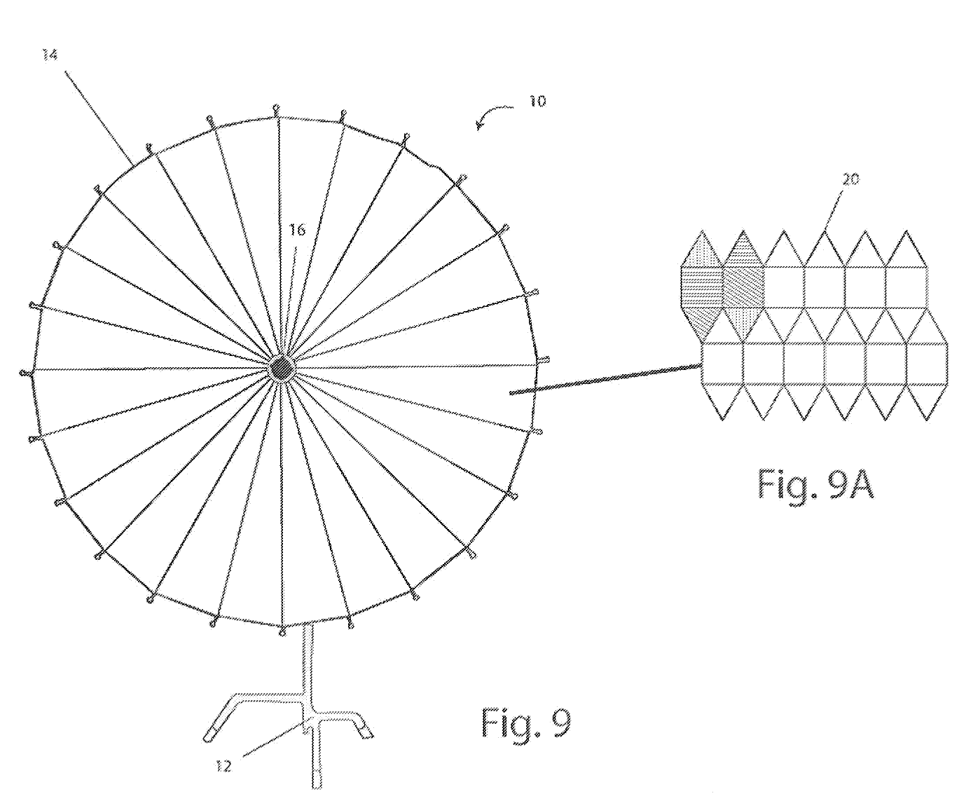

FIG. 9 illustrates an embodiment of tessellations 20 shown in another alternative pattern of polygons on the skin 14 and which have colors according to the RGB color space as illustrated in FIG. 1B.

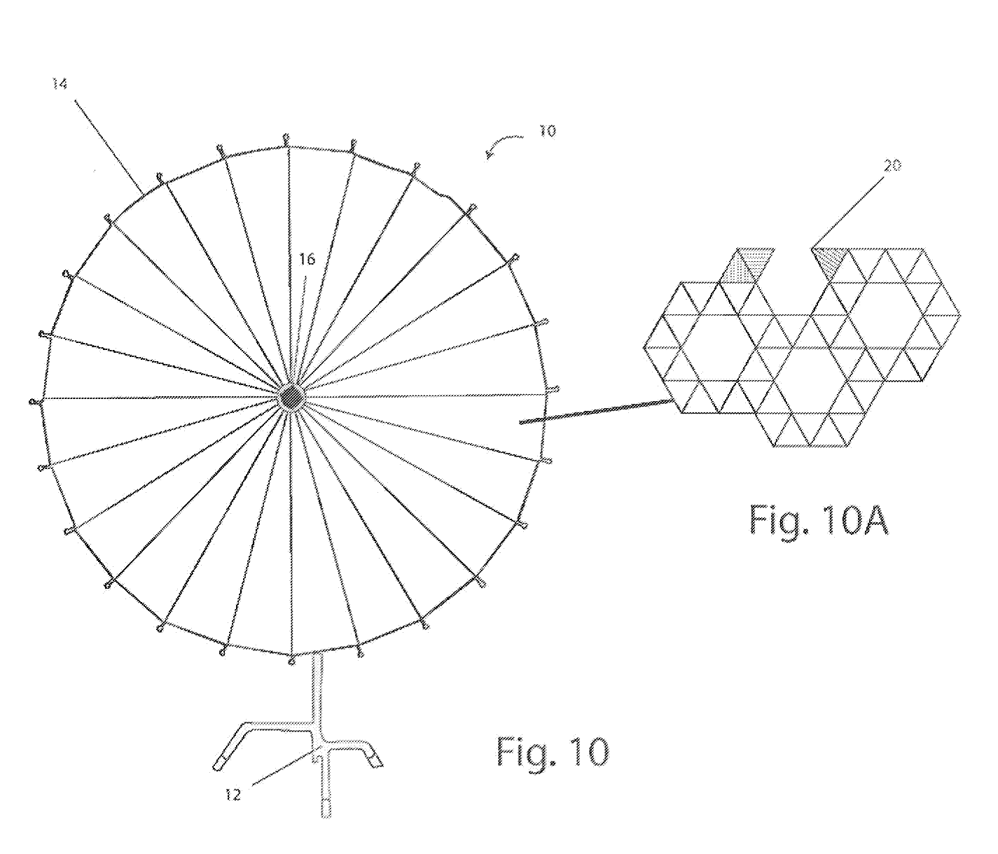

FIG. 10 illustrates an embodiment of tessellations 20 shown in another further alternative pattern of polygons on the skin 14 and which have colors according to the RGB color space as illustrated in FIG. 1B.

In alternative embodiments of the invention, the invention includes use of the CMYK color space to reflect light in a light reflector. In these embodiments of the invention, the skin 14 can be made of any textile, and the skin 14 can be substantially flat or planar or it can be embossed to give the skin 14 a three dimensional quality. In further embodiments, the skin 14 is aluminum, steel or any other kind of metal.

The geometric pattern or tessellations 20 are printed, painted or anodized directly on the surface of the skin 14, whether the skin 14 is made of a textile, metal or other material. The tessellations 20 can also be applied to the skin 14 by adhesive backed applications so that the tessellations 20 adhere to the skin 14 by the adhesive.

The CMYK values can be changed by various methods known to skilled persons, including using an asymmetrical tessellation pattern on the skin 14, varying the size of the individual color tessellations, varying the intensity of the colors, varying the colors or by adding or subtracting individual color tessellations so the number of each color tessellation is a pre-determined value. For example, in one embodiment using a pre-determined value, an equal number of tessellations of each color cyan, yellow, magenta and key are used.

A user desiring to use reflected light with a different color can replace the skin 14 on the light reflector 10 with a different skin 14 having tessellations 20 with the CMYK color space for the desired color of reflected light selected by the user.

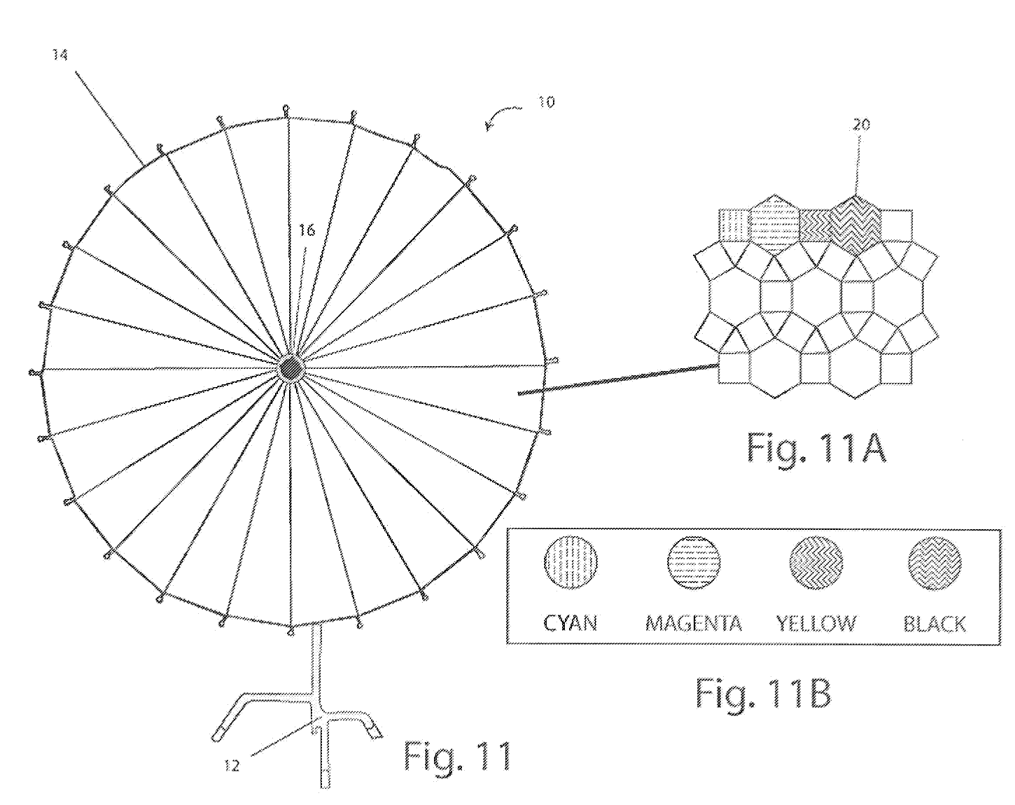

In the embodiment shown in FIG. 11, the skin 14 is imprinted with the tessellations 20 as shown in FIG. 11A. The tessellations 20 are colored according to the chosen color space which for these embodiments is the CMYK color space as illustrated in FIG. 11B. It is understood that FIG. 11B and the drawings of the tessellations 20 illustrate exemplary embodiments and that for clarity, the color lining is shown in the Figures applied only to selected individual tessellations 20. It is understood that the CMYK color space is and can be applied to the tessellations 20 over the full pattern of the tessellations 20 as applied to the skin 14.

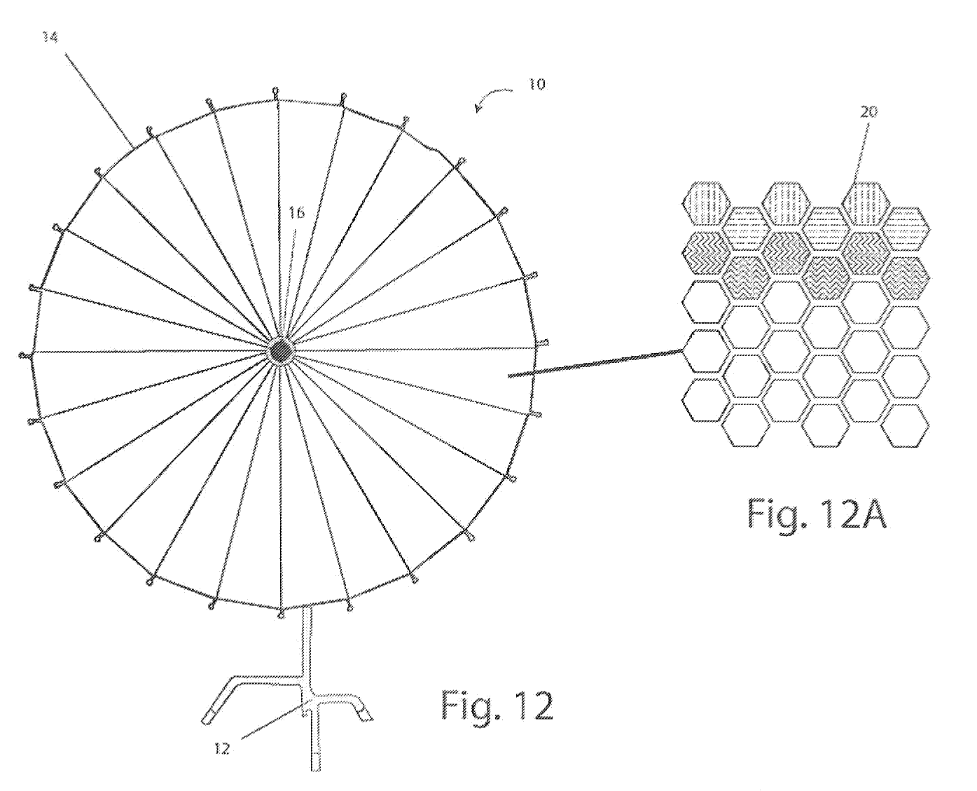

FIGS. 12-20 illustrate exemplary embodiments of the tessellations 20 that can be used to reflect light of different colors using the CMYK color space. The invention is not limited to the particular embodiments in the figures but includes geometric patterns that can be placed on the skin 14 and include the CMYK colors to produce desirable reflected light.

FIG. 12 illustrates an alternative embodiment with the tessellations 20 shown in a pattern of hexagon shapes which are imprinted onto the skin 14 and which have colors according to the CMYK color space as illustrated in FIG. 11B.

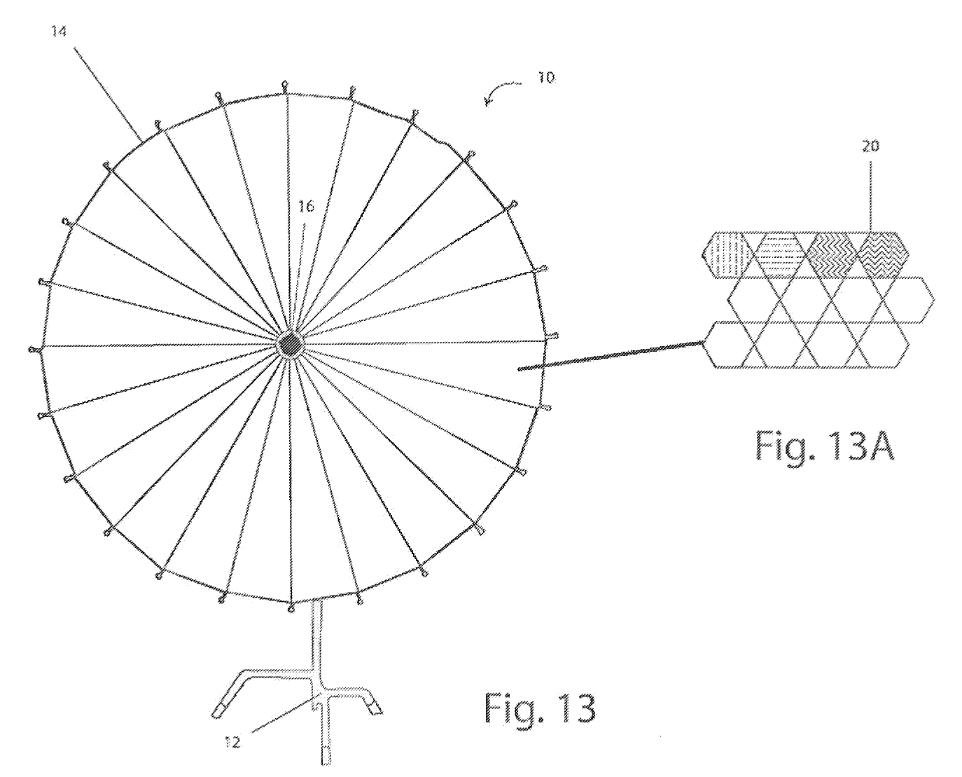

FIG. 13 illustrates an embodiment of tessellations 20 shown in an alternative pattern of hexagon shapes on the skin 14 and which have colors according to the CMYK color space as illustrated in FIG. 11B.

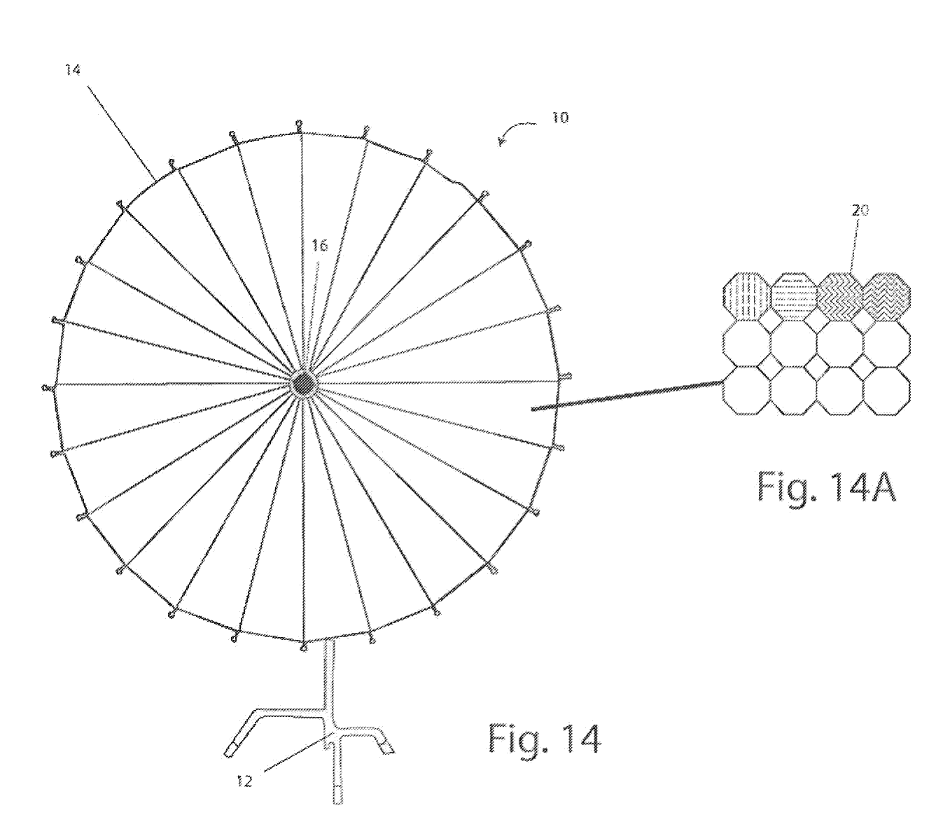

FIG. 14 illustrates an embodiment of tessellations 20 shown in another pattern of hexagon shapes on the skin 14 and which have colors according to the CMYK color space as illustrated in FIG. 11B.

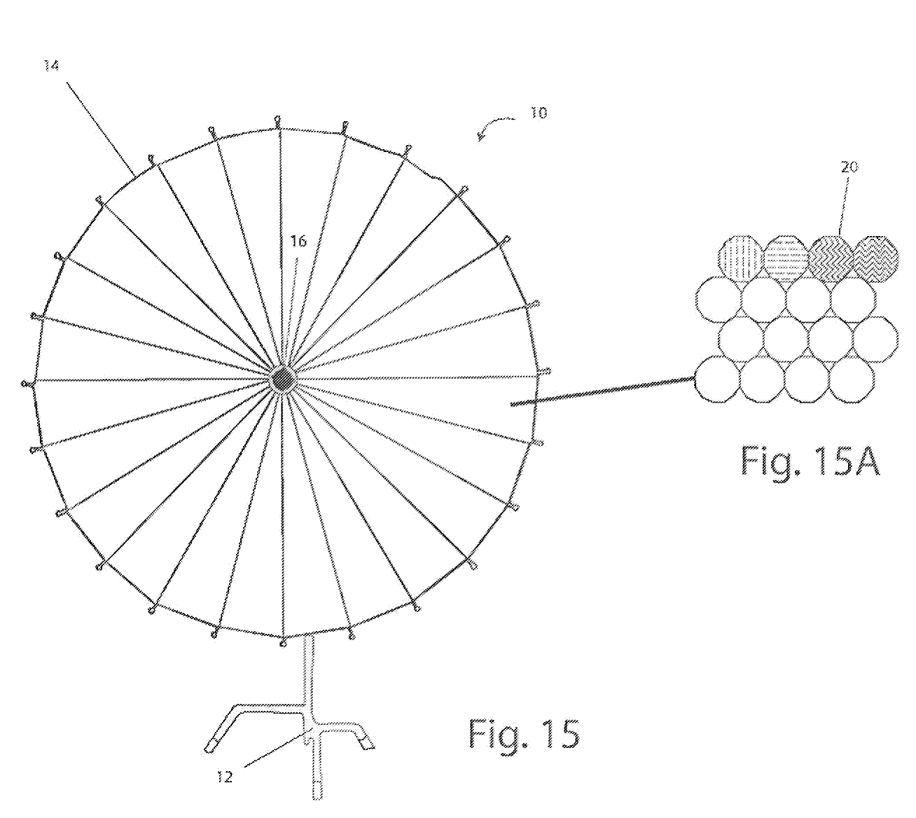

FIG. 15 illustrates an embodiment of tessellations 20 shown in a pattern of octagon shapes on the skin 14 and which have colors according to the CMYK color space as illustrated in FIG. 11B.

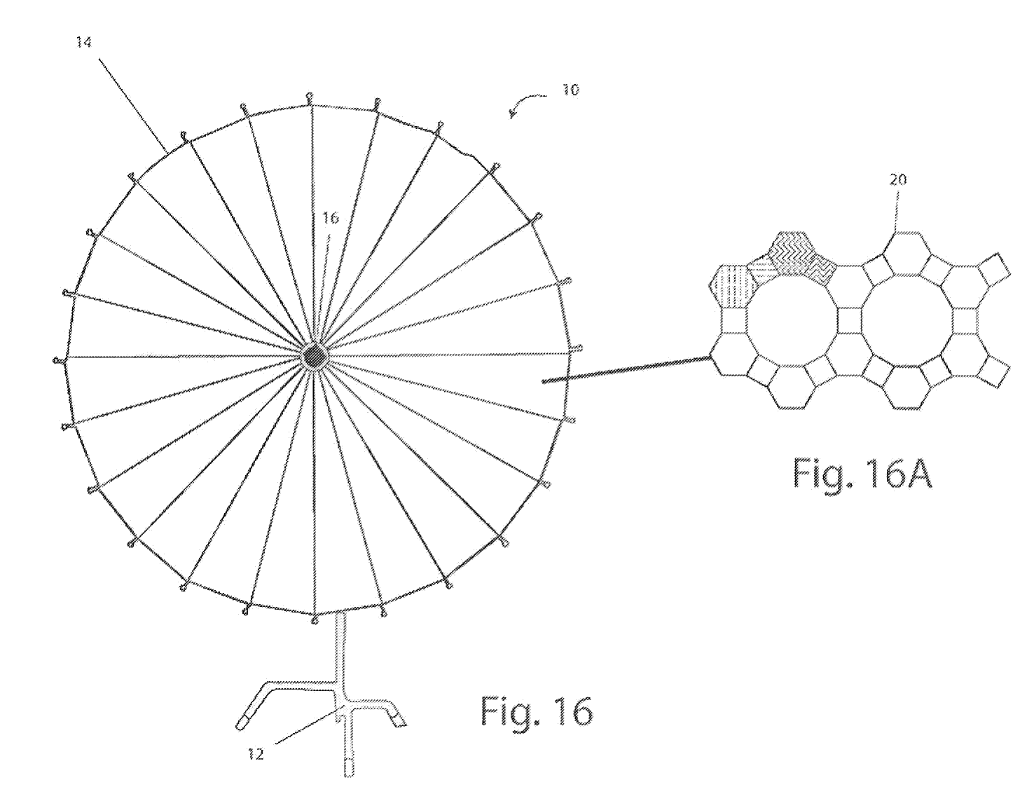

FIG. 16 illustrates an embodiment of tessellations 20 shown in an alternative pattern of polygons on the skin 14 and which have colors according to the CMYK color space as illustrated in FIG. 11B.

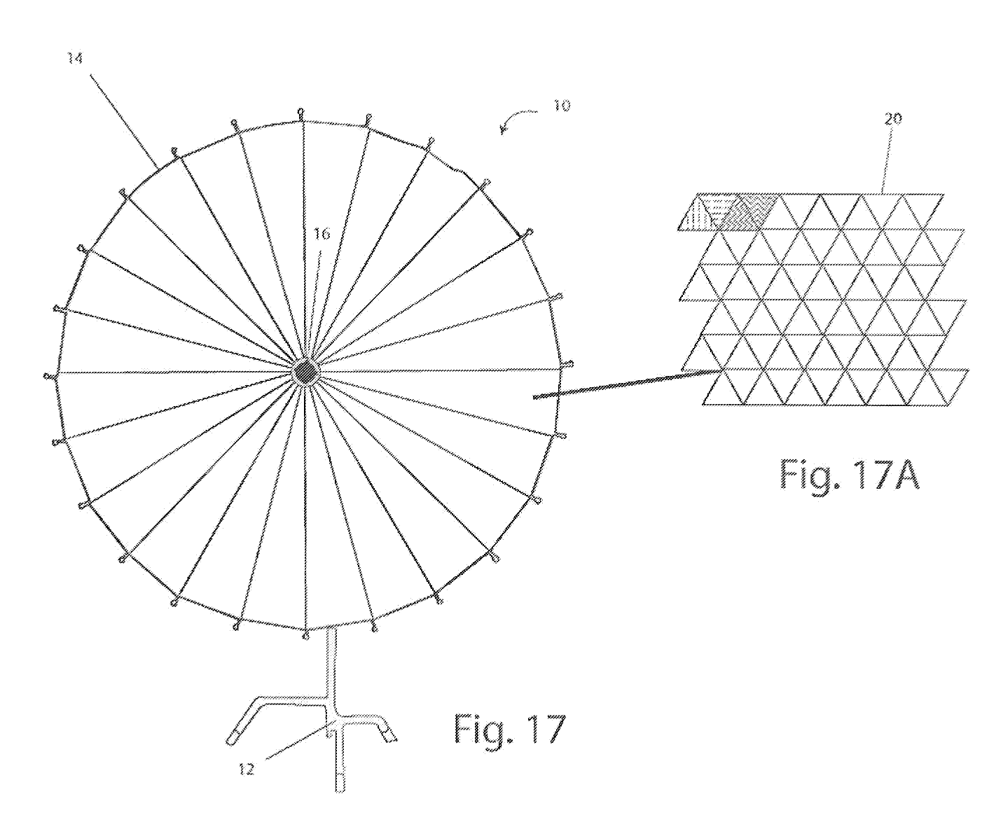

FIG. 17 illustrates an embodiment of tessellations 20 shown in a pattern of triangle shapes on the skin 14 and which have colors according to the CMYK color space as illustrated in FIG. 11B.

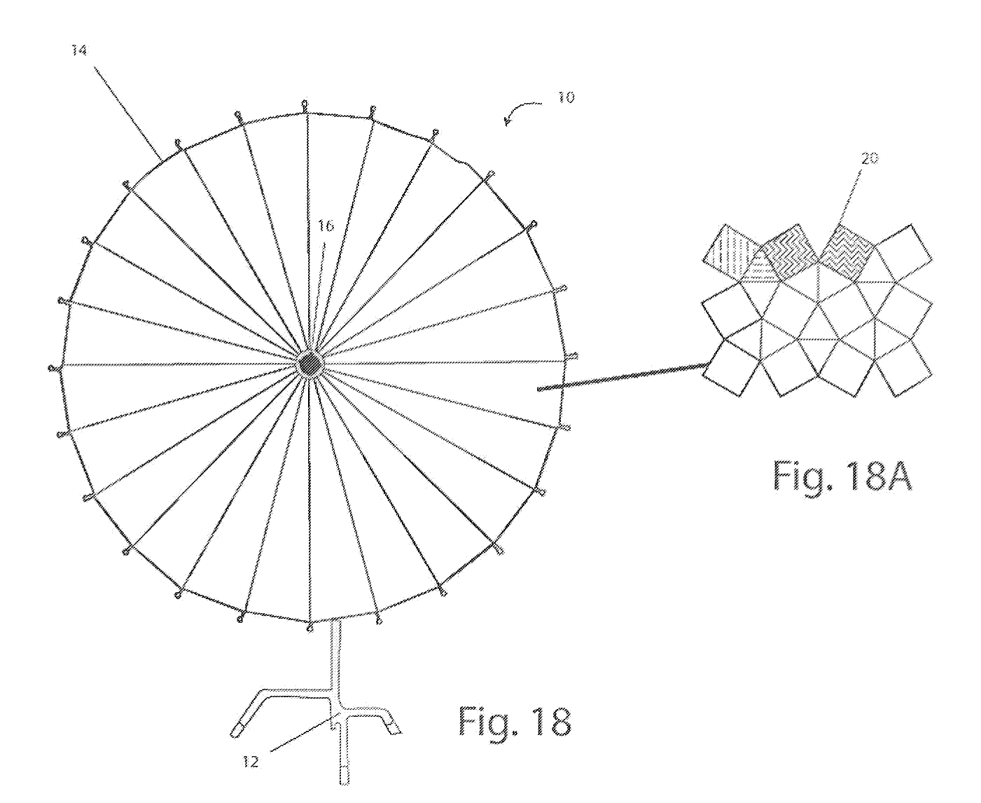

FIG. 18 illustrates an embodiment of tessellations 20 shown in a further alternative pattern of polygons on the skin 14 and which have colors according to the CMYK color space as illustrated in FIG. 11B.

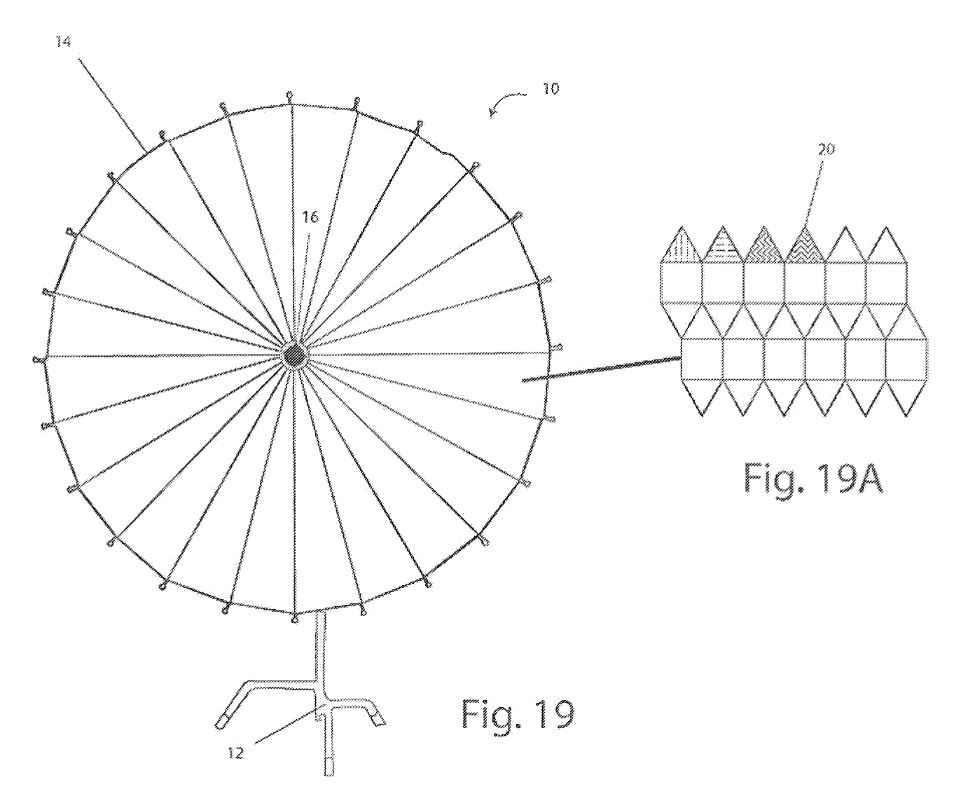

FIG. 19 illustrates an embodiment of tessellations 20 shown in another alternative pattern of polygons on the skin 14 and which have colors according to the CMYK color space as illustrated in FIG. 11B.

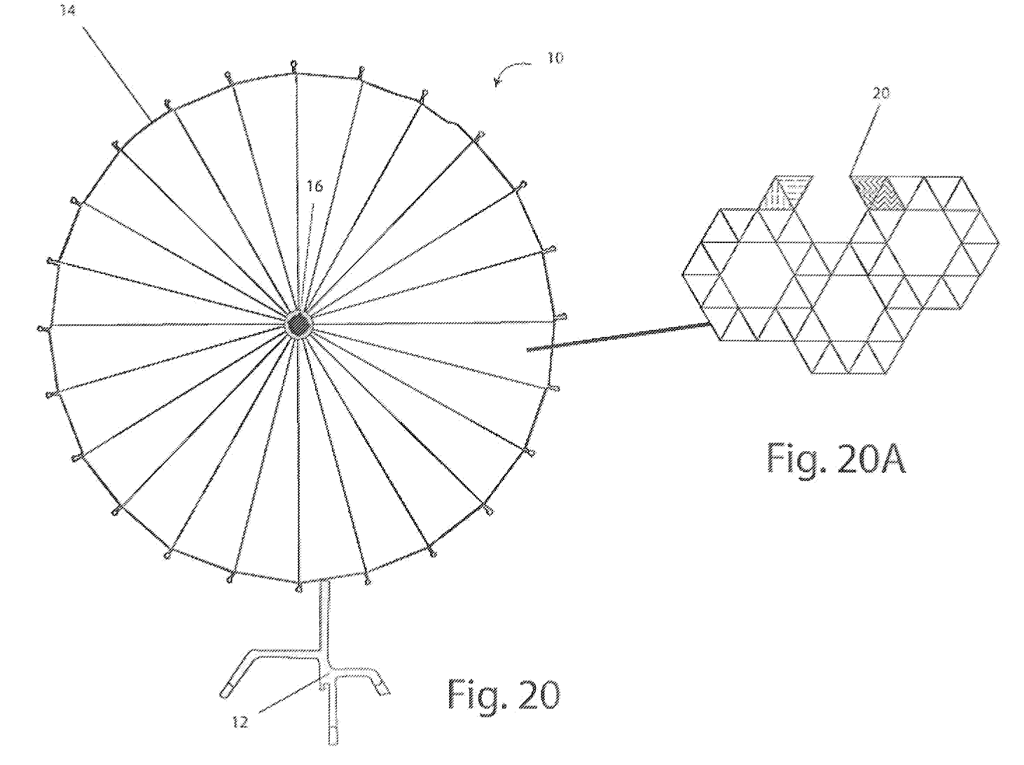

FIG. 20 illustrates an embodiment of tessellations 20 shown in another further alternative pattern of polygons on the skin 14 and which have colors according to the CMYK color space as illustrated in FIG. 11B.

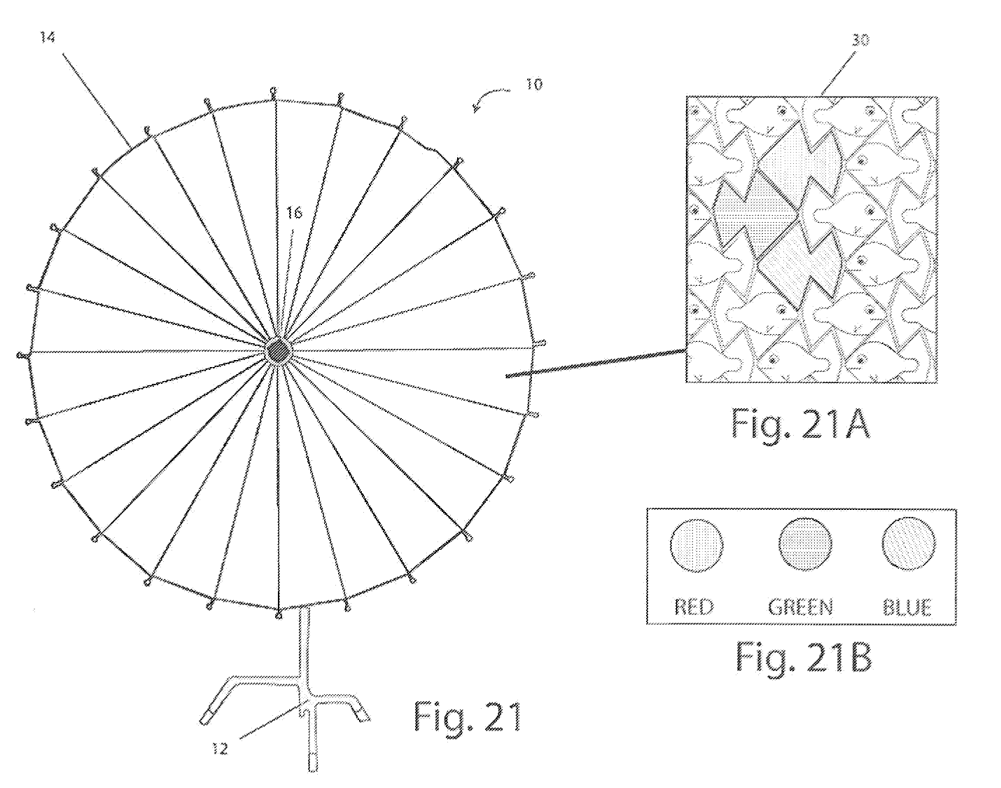

Further embodiments of the invention include other patterns on the skin 14 to produce desirable reflected light. In the embodiment shown in FIG. 21, the skin 14 is imprinted with a design 30 as shown in FIG. 21A. The design 30 has colors according to the chosen color space which for this embodiment is the RGB color space as illustrated in FIG. 21B.

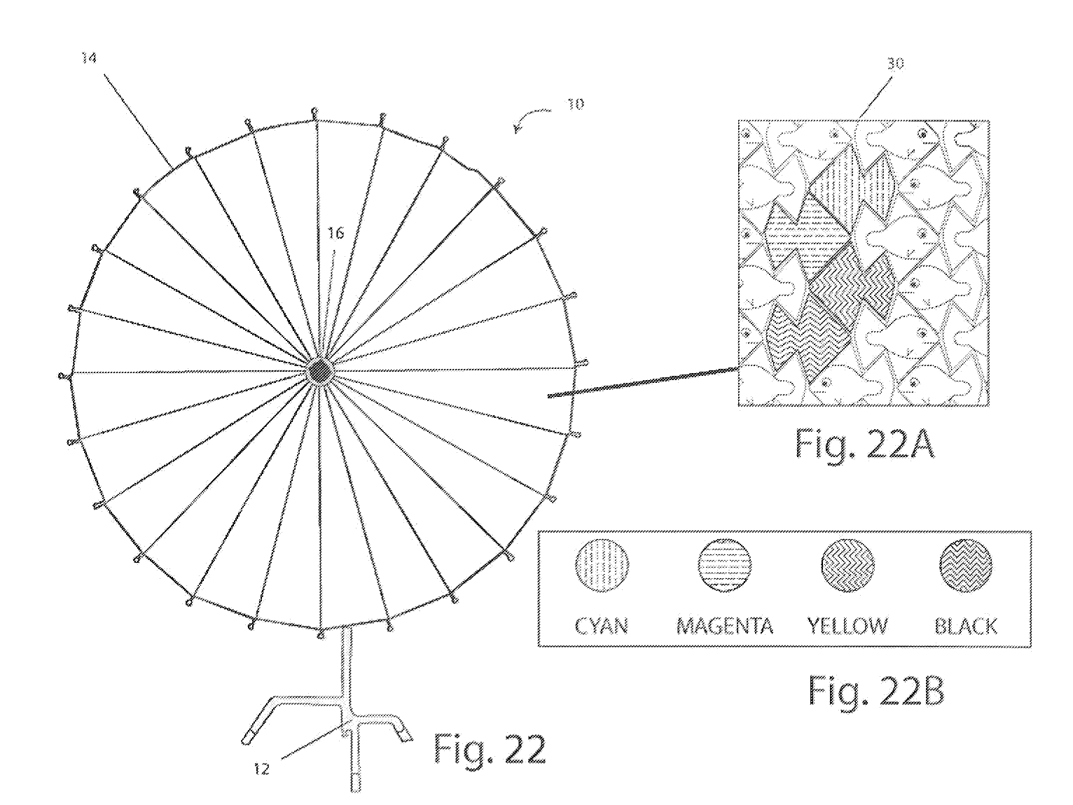

FIG. 22 shows an embodiment with the skin 14 imprinted with the design 30 as shown in FIG. 22A and the design 30 has colors according to the CMYK color space as illustrated in FIG. 22B. The invention includes the use of alternative designs and is not limited to the design shown in the Figures.

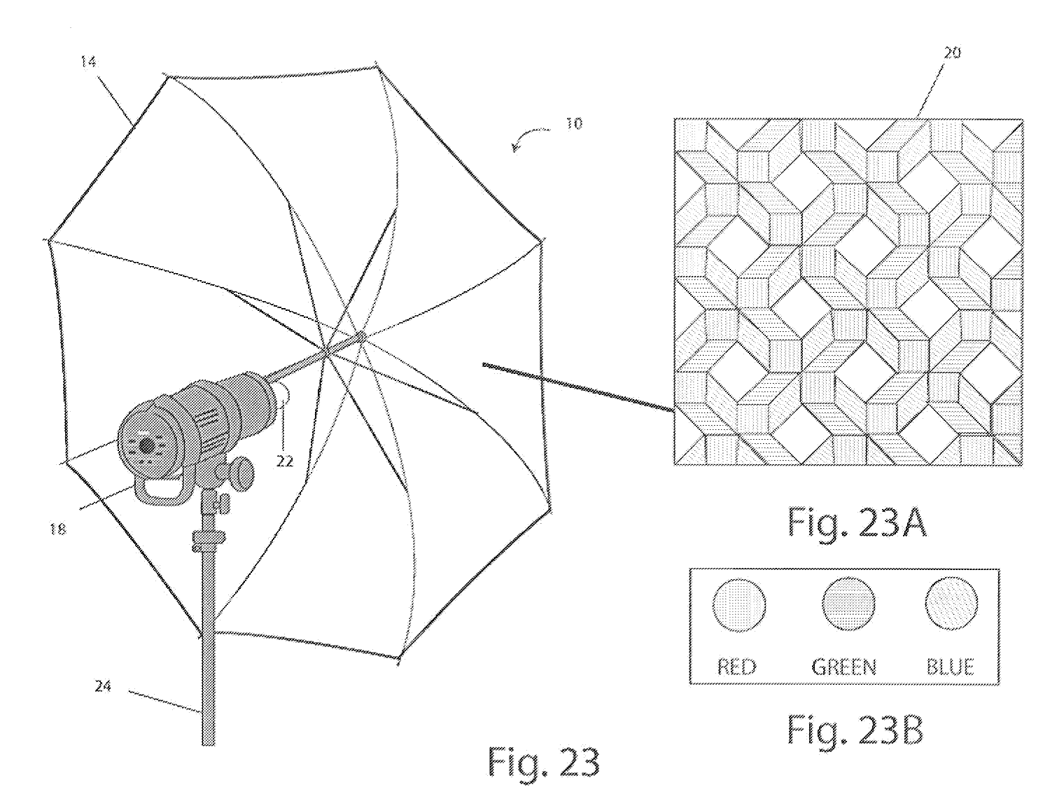

FIG. 23 illustrates another embodiment of the invention where the skin 14 is secured to a light reflector umbrella 10. The umbrella 10 is secured to the flash head 18 that is supported on the flash head support 24. The flash head 18 includes the bulb or light source 22 as shown in FIG. 23. The flash head 18 is connected to an electric•supply (not shown) to provide appropriate electric current to the light source 22. In the embodiment shown in FIG. 23, light produced from the light source 22 for the light reflector 10 is reflected off of the tessellations 20 on the skin 14 as shown in FIGS. 23 and 23A. The tessellations 20 have colors according to the RGB color space as illustrated in FIG. 23B to reflect light outward from the reflector 10 having one or more desired colors.

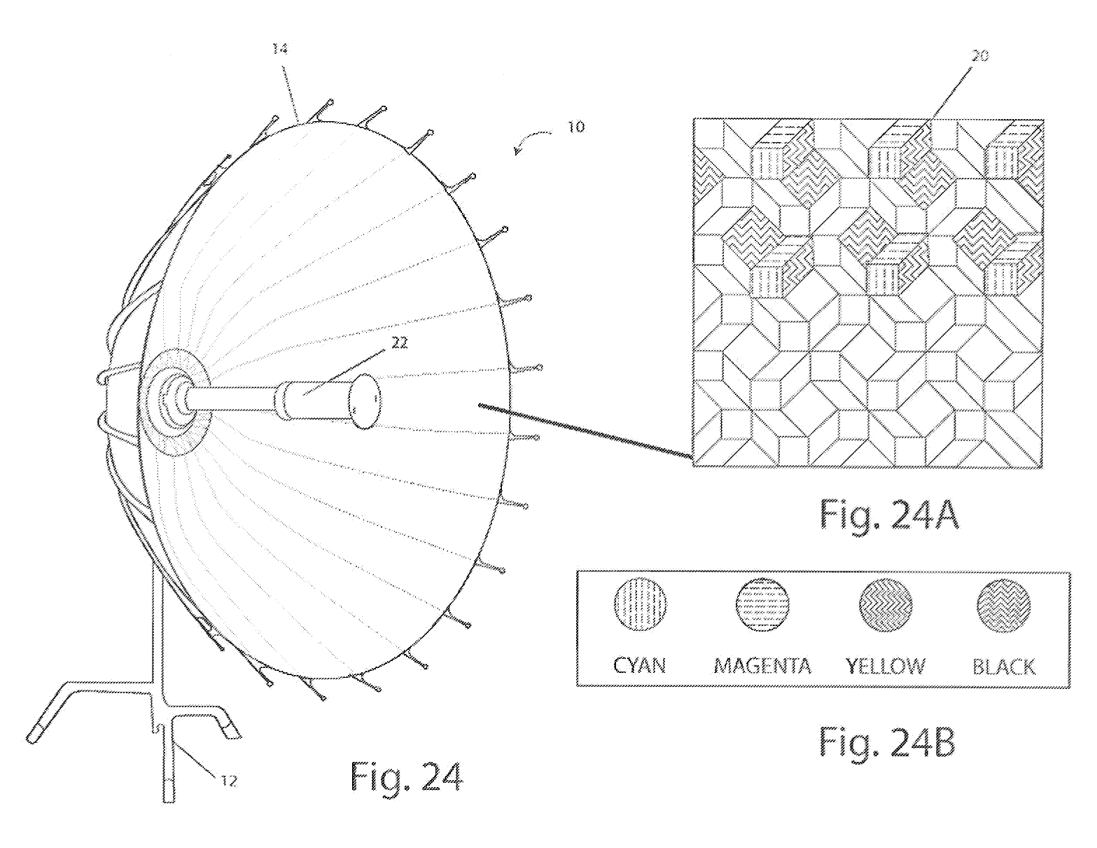

FIG. 24 illustrates an embodiment of the invention where the skin 14 is secured to a light reflecting parabolic umbrella 10. The umbrella 10 is secured to the light source 22 as shown in FIG. 24 and which in use is connected to an electric supply (not shown) to provide electric current to the light source 22. In the embodiment shown in FIG. 24, light produced from the light source 22 for the parabolic umbrella 10 is reflected off of the tessellations 20 on the skin 14 as shown in FIGS. 24 and 24A. The tessellations 20 have colors according to the CMYK color space as illustrated in FIG. 24B to reflect light outward from the umbrella 10 having one or more desired colors.

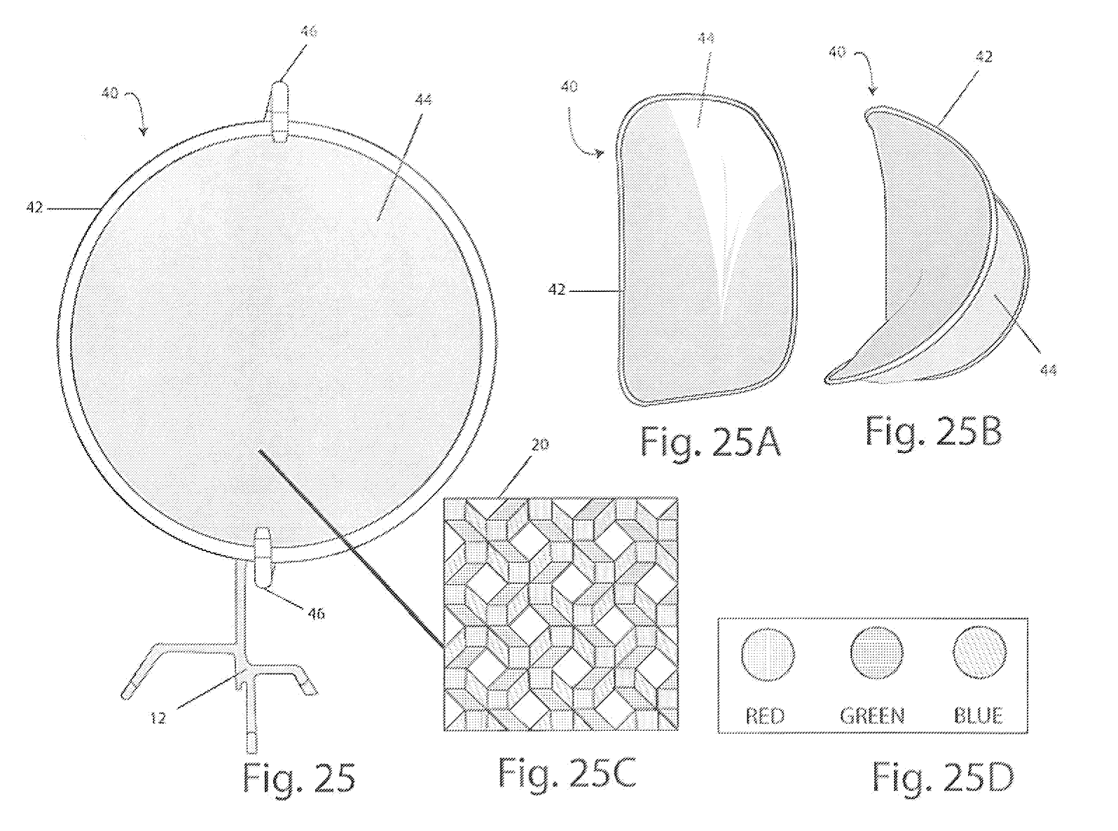

FIG. 25 illustrates an embodiment of the invention as a light bounce board 40. In this embodiment, the bounce board 40 includes the frame 42 attached to the surface 44 by conventional methods. The board 40 is secured to the support 12 by one or more clips 46 that are connected to the support 12 by standard connections (not shown) to position the board 40 as desired by a photographer, cinematographer or other user of the board 40.

FIG. 25A and FIG. 25B illustrate additional embodiments where the bounce board 40 is held by an individual with no need for the support 12 and where the bounce board 40 is configured in various shapes and sizes. The bounce board 40 includes embodiments where the board 40 can be partially folded as shown in FIG. 25B. The invention is not limited to a particular size, shape or configuration of the bounce board 40 and the invention includes all sizes, shapes and configurations known to skilled persons.

The surface 44 can be made of a textile, metal, plastic, ceramic, glass and other materials known to skilled persons to reflect light for photography or cinematography, all of which are within the scope of the invention. In the embodiments in FIGS. 25, 25A and 25B, the tessellations 20 shown in FIG. 25C are placed on the surface 44 so that light from a light source (not shown) is reflected off of the tessellations 20 with the reflected light having one or more desired colors. The tessellations 20 as shown in FIG. 25C are placed onto the surface 44 by methods known to skilled persons and the tessellations can be printed on, dyed onto, glued to, woven onto, painted on, anodized to and laminated onto the surface 44, all of which are within the scope of the invention. For the embodiments in FIGS. 25, 25A and 25B, the tessellations 20 have colors according to the RGB color space as illustrated in FIG. 25C and FIG. 25D. For these embodiments, the pattern of tessellations 20 is not limited to a particular configuration but includes all such tessellations known to skilled persons.

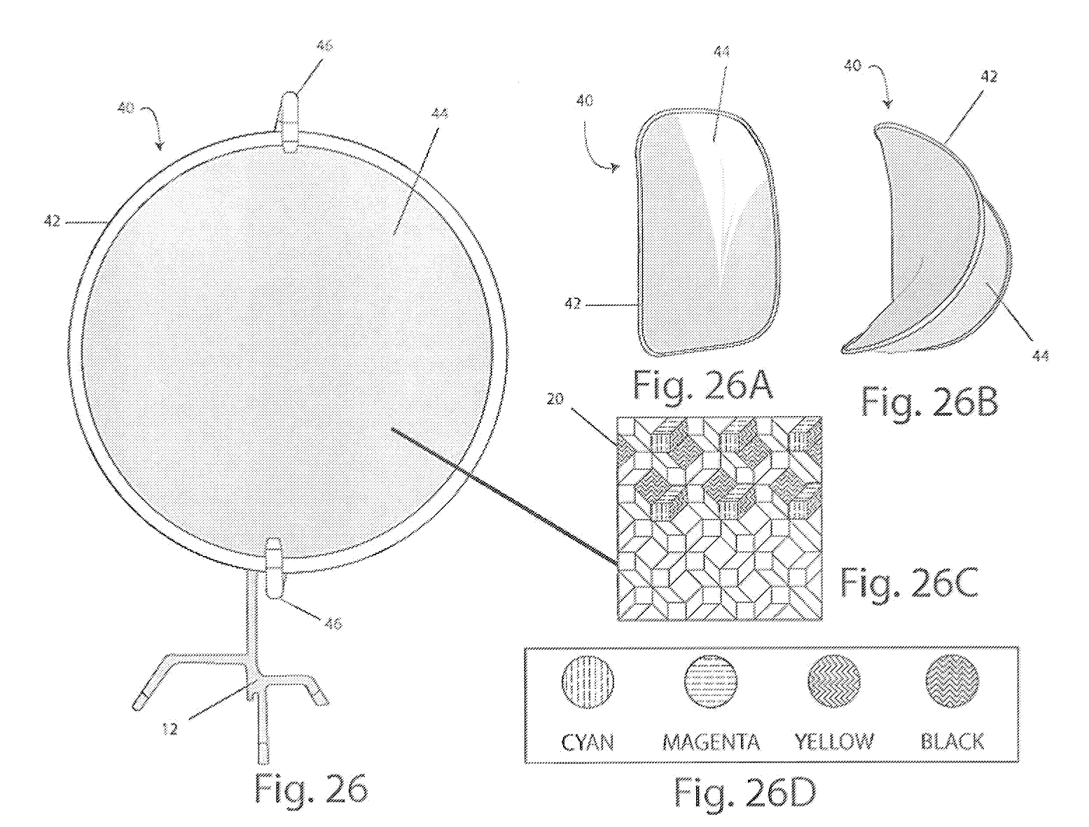

FIG. 26 illustrates another embodiment of the invention as a light bounce board 40. The bounce board 40 includes the frame 42 attached to the surface 44 by conventional methods. The board 40 is secured to the support 12 by one or more clips 46 that are connected to the support 12 by standard connections (not shown) to position the board 40 as desired by a photographer, cinematographer or other user of the board 40.

FIG. 26A and FIG. 26B illustrate additional embodiments where the bounce board 40 is held by an individual with no need for the support 12 and where the bounce board 40 is configured in various shapes and sizes, including being partially folded as shown in FIG. 25B. The invention is not limited to a particular size, shape or configuration of the bounce board 40 and the invention includes all sizes, shapes and configurations known to skilled persons. For these embodiments, the surface 44 can be made of a textile, metal, plastic, ceramic, glass and other materials known to skilled persons to reflect light used for photography or cinematography, all of which are within the scope of the invention.

In the embodiments in FIGS. 26, 26A and 26B, the tessellations 20 shown in FIG. 26C are placed on the surface 44 so that light from a light source (not shown) is reflected off of the tessellations 20 with the reflected light having one or more desired colors. The tessellations 20 as shown in FIG. 26C are placed onto the surface 44 by methods known to skilled persons and the tessellations can be printed on, dyed onto, glued to, woven onto, painted on, anodized to and laminated onto the surface 44, all of which are within the scope of the invention. For the embodiments in FIGS. 26, 26A and 26B, the tessellations 20 have colors according to the CMYK color space as illustrated in FIG. 26C and FIG. 26D. For these embodiments, the pattern of tessellations 20 is not limited to a particular configuration but includes all such tessellations known to skilled persons.

While the present invention has been described with regards to particular embodiments, it is recognized that additional variations of the present invention may be devised by persons skilled in the art without departing from the inventive concepts disclosed herein and the invention is entitled to the full breadth and scope of the claims.

What is claimed is:

1. A skin having a light reflecting surface adapted to reflect light from a light source secured to a parabolic light reflector, the light reflecting surface comprising a selected pattern of an RGB color space thereon to reflect light from the light source so that the reflected light has a color based on the selected pattern of the RGB color space.

2. The skin of claim 1 where the selected pattern of the RGB color space is applied to tessellations on the light reflecting surface.

3. The skin of claim 1 where the selected pattern of the RGB color space is applied to designs on the light reflecting surface.

4. The skin of claim 1 wherein the skin is adapted to be secured to a light reflecting umbrella.

5. A skin having a light reflecting surface adapted to reflect light from a light source secured to a parabolic light reflector, the light reflecting surface comprising a selected pattern of the CMYK color space thereon to reflect light from the light source so that the reflected light has a color based on the selected pattern of the CMYK color space.

6. The skin of claim 5 where the selected pattern of the CMYK color space is applied to tessellations on the light reflecting surface.

7. The skin of claim 5 where the selected pattern of the CMYK color space is applied to designs on the light reflecting surface.

8. The skin of claim 5 wherein the skin is adapted to be secured to a light reflecting umbrella.

9. A method for making a reflecting surface for a light reflector, comprising the steps of:
applying a pattern onto a light reflecting surface;
selecting a combination of a plurality of colors from a color space to reflect light having a preselected color based on the combination of plurality of colors from the color space; and
applying the selected combination of a plurality of colors onto the pattern on the light reflecting surface.

10. The method of claim 9 wherein the color space is the RGB color space.

11. The method of claim 9 wherein the color space is the CMYK color space.

12. The method of claim 9 wherein the pattern on the light reflecting surface comprises one or more tessellations.

13. The method of claim 9 wherein the pattern on the light reflecting surface comprises one or more designs.

14. The method of claim 9 further comprising the step of applying the light reflecting surface to a bounce board.

15. The method of claim 9 further comprising the step of applying the light reflecting surface to an umbrella skin adapted for use with a parabolic light reflector.

16. The method of claim 9 wherein the light reflecting surface is adapted for use with a soft box, an octobank or strip lights.

17. A light reflecting surface adapted to reflect light from a light source secured to a bounce board, the light reflecting surface comprising a selected pattern of a color space thereon to reflect light from a light source so that the reflected light has a color based on the selected pattern of the color space.

18. The light reflecting surface of claim 17 wherein the color space is the RGB color space.

19. The light reflecting surface of claim 17 wherein the color space is the CMYK color space.
